(19) United States
(12) Patent Application Publication
(10) Pub. No.: US 2026/0160965 A1
(43) Pub. Date: Jun. 11, 2026

(54) OPTICAL CONNECTOR CABLE

(71) Applicant: SUMITOMO ELECTRIC INDUSTRIES, LTD., Osaka (JP)

(72) Inventor: Yasunori ASANO, Osaka-shi (JP)

(73) Assignee: SUMITOMO ELECTRIC INDUSTRIES, LTD., Osaka (JP)

(21) Appl. No.: 19/061,155

(22) Filed: Feb. 24, 2025

(30) Foreign Application Priority Data
Mar. 27, 2004 (JP) 2024-050875

(51) Int. Cl. G02B 6/42

(52) U.S. Cl. CPC G02B 6/428; G02B 6/4206

(57) ABSTRACT

An optical connector cable includes a circuit board, a photoelectric conversion element provided at the circuit board, a cable including an optical fiber configured to propagate light input to the photoelectric conversion element or light output from the photoelectric conversion element, a lens module including a lens configured to optically couple the photoelectric conversion element to the optical fiber, and a connection terminal provided at a surface of the circuit board and electrically connected to the circuit board. The connection terminal is configured to be elastically deformable.

### CROSS-REFERENCE TO RELATED APPLICATIONS

This application claims priority based on Japanese Patent Application No. 2024-050875 filed on Mar. 27, 2024, the entire contents of which are incorporated herein by reference.

### TECHNICAL FIELD

The present disclosure relates to an optical connector cable.

### BACKGROUND

An electrical connector including a circuit board and a signal wire electrically connected to the circuit board is known (see, for example, Patent Document 1: U.S. Patent Application Publication No. 2021/0143569). In the electrical connector described in Patent Document 1, a connection terminal configured to be elastically deformable is provided on the circuit board.

### SUMMARY

An optical connector cable according to the present disclosure includes a circuit board; a photoelectric conversion element provided at the circuit board; a cable including an optical fiber configured to propagate light input to the photoelectric conversion element or light output from the photoelectric conversion element; a lens module including a lens configured to optically couple the photoelectric conversion element to the optical fiber; and a connection terminal provided at a surface of the circuit board and electrically connected to the circuit board. The connection terminal is configured to be elastically deformable.

### BRIEF DESCRIPTION OF THE DRAWINGS

FIG. 1 is a perspective view of an optical connector cable according to an embodiment.

FIG. 2 is a perspective view of an internal structure of the connector illustrated in FIG. 1.

FIG. 3 is a cross-sectional view of the connector along line III-III illustrated in FIG. 2

FIG. 4 is a cross-sectional view of the connector along line IV-IV illustrated in FIG. 2.

FIG. 5 is a side view of the connector illustrated in FIG. 1.

FIG. 6 is a cross-sectional view of an optical connector cable according to a modification.

### DETAILED DESCRIPTION

According to the connector described in Patent Document 1, since the connection terminal is configured to be elastically deformable, even if there is a variation in the dimensions of the circuit board or the mating connector, the electrical connection between the circuit board and the mating connector by the connection terminal is ensured. There are cases where such ensured electrical connection is required for an optical connector cable including a circuit board and an optical fiber.

An object of the present disclosure is to provide an optical connector cable that can ensure the electrical connection.

### Description of Embodiments of the Present Disclosure

First, the contents of embodiments of the present disclosure will be listed and described.
(1) An optical connector cable of the present disclosure includes a circuit board; a photoelectric conversion element provided at the circuit board; a cable including an optical fiber configured to propagate light input to the photoelectric conversion element or light output from the photoelectric conversion element; a lens module including a lens configured to optically couple the photoelectric conversion element to the optical fiber; and a connection terminal provided at a surface of the circuit board and electrically connected to the circuit board. The connection terminal is configured to be elastically deformable.

The optical connector cable described in the above (1) includes the connection terminal provided at the surface of the circuit board. Thus, a mating connector can be electrically connected to the circuit board by the connection terminal. Moreover, the connection terminal is configured to be elastically deformable. Thus, even if the circuit board or the mating connector has dimensional variations, the electrical connection between the circuit board and the mating connector is ensured by the connection terminal. Therefore, according to the optical connector cable, the electrical connection can be ensured.
(2) The optical connector cable described in the above (1) may include a housing configured to accommodate the circuit board, the photoelectric conversion element, the lens module, and the connection terminal therein. The housing may have an opening. A tip of the connection terminal may protrude the opening to an outside of the housing. According to this optical connector cable, even if the housing has dimensional variations, the electrical connection between the circuit board and the mating connector is ensured by the connection terminal.
(3) In the optical connector cable described in the above (2), the lens module may include a supporting surface parallel to an axial direction of the optical fiber and configured to support the optical fiber. The housing may include a protruding portion facing the supporting surface with the optical fiber interposed between the protruding portion and the supporting surface and configured to press the optical fiber against the supporting surface. According to this optical connector cable, the optical fiber is pressed against the supporting surface by the protruding portion, and thus the displacement of the optical fiber is prevented.

(4) In the optical connector cable described in any one of (1) to (3), the circuit board may include a first main surface and a second main surface opposite to the first main surface. The photoelectric conversion element, the optical fiber, the lens module, and the connection terminal may be located on a side of the first main surface opposite to the second main surface. This enables the optical connector cable to be downsized.

(5) The optical connector cable described in the above (4) may further include a signal wire electrically connected to the circuit board and configured to transmit an electric signal input to the circuit board or an electric signal output from the circuit board, and a ground wire electrically connected to the circuit board. The signal wire may be located on a side of the second main surface opposite to the first main surface. The ground wire may be located on the side of the first main surface opposite to the second main surface. According to this optical connector cable, both the first main surface and the second main surface of the circuit board can be utilized, and thus the optical connector cable can be downsized.

### Details of Embodiments of the Present Disclosure

Specific examples of the optical connector cable of the present disclosure will be described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description thereof will be omitted.

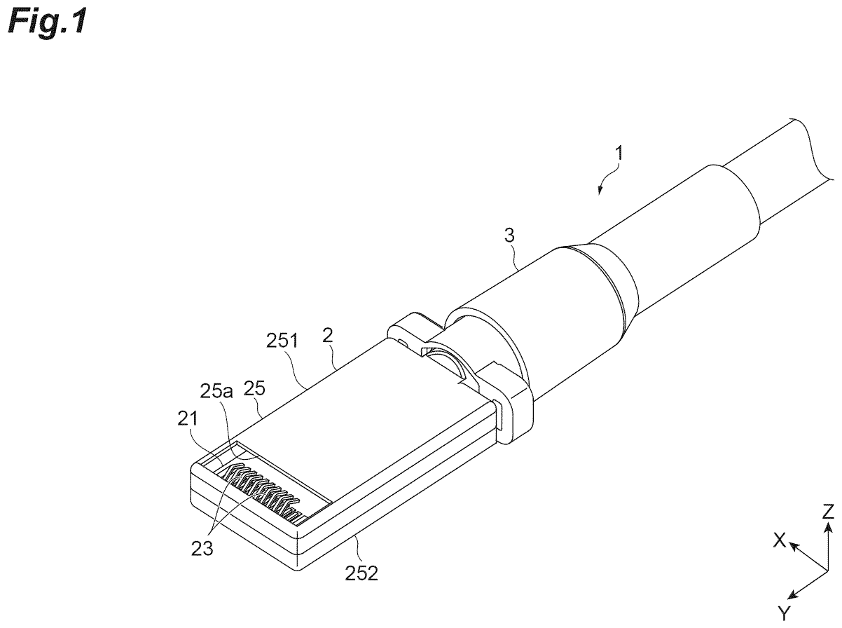

FIG. 1 is a perspective view of an optical connector cable according to the present embodiment. An optical connector cable 1 illustrated in FIG. 1 is used for, for example, transmission and reception of light signals between devices. Optical connector cable 1 is, for example, an active optical cable (AOC) or the like. Although one end of optical connector cable 1 is illustrated in FIG. 1, the other end of optical connector cable 1 may have the same configuration as that of the one end of optical connector cable 1.

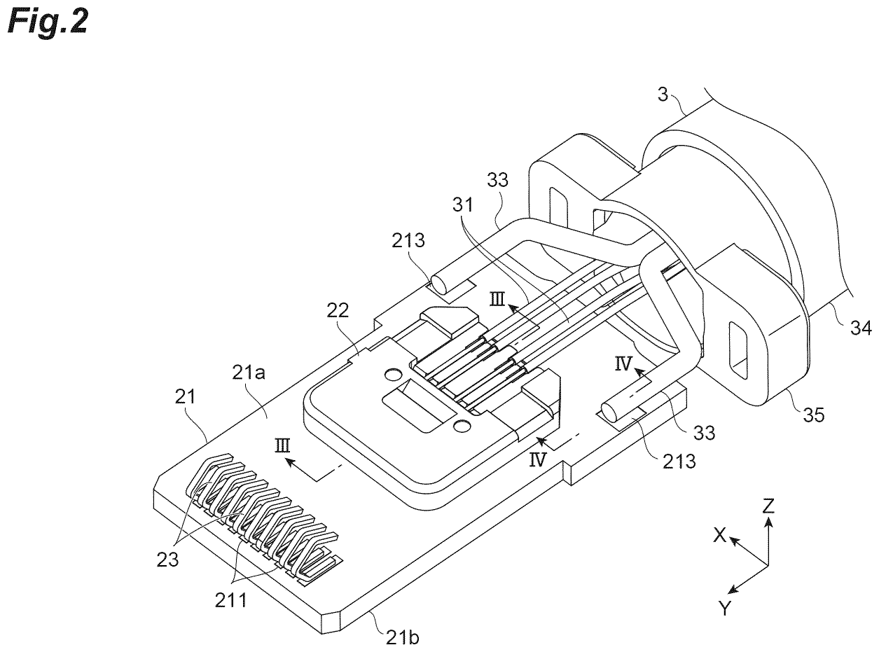

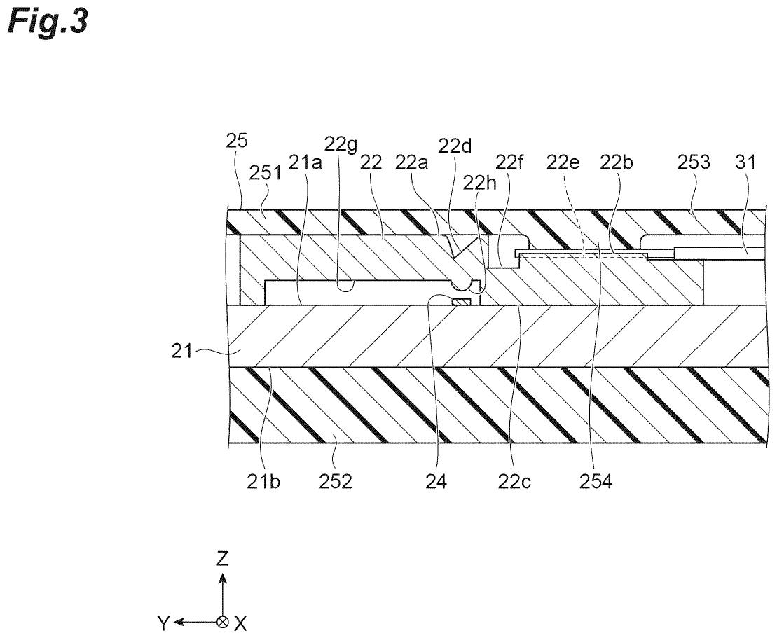

FIG. 2 is a perspective view of an internal structure of a connector 2 illustrated in FIG. 1. As illustrated in FIG. 1 and FIG. 2, optical connector cable 1 includes connector 2 and a cable 3. Connector 2 includes a circuit board 21, a lens module 22, a plurality of connection terminals 23, and a plurality of photoelectric conversion elements 24 (see FIG. 3), and a housing 25.

Circuit board 21 has, for example, a plate shape. Circuit board 21 is provided with an optical element, an electronic element, and the like. Circuit board 21 includes a first main surface 21a and a second main surface 21b. Second main surface 21b faces away from first main surface 21a. Each of first main surface 21a and second main surface 21b is a flat surface intersecting with a Z-axis direction (a thickness direction of circuit board 21). Wiring and the like are provided inside circuit board 21.

Lens module 22 is provided at circuit board 21. Lens module 22 is located on a side of first main surface 21a of circuit board 21 opposite to second main surface 21b. Lens module 22 is disposed on first main surface 21a. Lens module 22 is fixed to first main surface 21a with, for example, an adhesive or the like. The adhesive is, for example, an ultraviolet curable adhesive. Lens module 22 has a light transmittance. Lens module 22 is made of, for example, glass or resin.

Each of connection terminals 23 is provided at the surface of circuit board 21. Each of connection terminals 23 is located on the side of first main surface 21a of circuit board 21 opposite to second main surface 21b. Each of connection terminals 23 is disposed on first main surface 21a. Each of connection terminals 23 is located on a side of lens module 22 opposite to cable 3. The plurality of connection terminals 23 are arranged side by side along the X-axis direction. Each of connection terminals 23 is fixed to an electrode pad 211 provided on first main surface 21a of circuit board 21 with, for example, soldering. Thus, each of connection terminals 23 is electrically connected to circuit board 21.

Housing 25 accommodates circuit board 21, lens module 22, connection terminals 23, and photoelectric conversion elements 24 therein. Housing 25 is formed from an insulating material such as liquid crystal polymer (LCP), polyphenylene sulfide (PPS), polybutylene terephthalate (PBT), acrylonitrile-butadiene-styrene resin (ABS), and so on, for example. Housing 25 includes a first member 251 and a second member 252. First member 251 is located on the side of first main surface 21a of circuit board 21 opposite to second main surface 21b. Second member 252 is located on a side of second main surface 21b of circuit board 21 opposite to first main surface 21a. First member 251 and second member 252 are engaged with each other in a state where circuit board 21, lens module 22, connection terminals 23, and photoelectric conversion elements 24 are accommodated therein. First member 251 and the second member 252 of the housing 25 are arranged so as not to contact the plurality of connection terminals 23.

An opening 25a is formed at a surface of first member 251. Opening 25a is provided, for example, near the tip of optical connector cable 1. The inner space of housing 25 communicate with the outside of housing 25 through opening 25a. Opening 25a overlaps with the plurality of connection terminals 23 when viewed from the Z-axis direction. The inner edge of opening 25a surrounds the plurality of connection terminals 23 when viewed from the Z-axis direction.

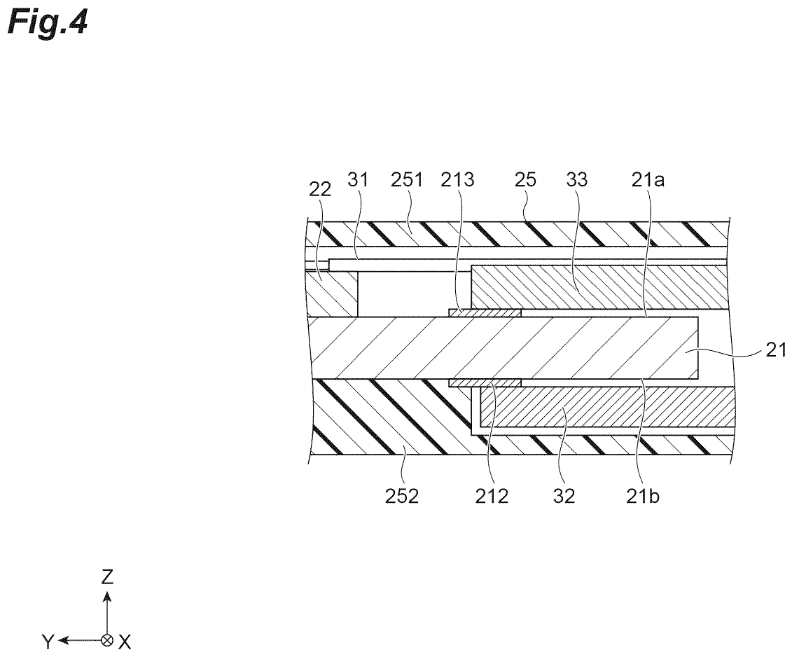

Cable 3 includes a plurality of optical fibers 31, a plurality of signal wires 32 (see FIG. 4), a plurality of ground wires 33, a cable jacket 34, and a holding member 35. Optical fibers 31 propagate light input to photoelectric conversion elements 24 or light output from photoelectric conversion elements 24. Each of optical fibers 31 includes, for example, a core, a cladding surrounding the core, and a resin covering the cladding. Each of optical fibers 31 is a single-mode optical fiber (SMF) or a multi-mode optical fiber (MMF). Each of optical fibers 31 is located on the side of first main surface 21a of circuit board 21 opposite to second main surface 21b.

Each of signal wires 32 transmits an electric signal input to circuit board 21 or an electric signal output from circuit board 21. Each of signal wires 32 and ground wires 33 includes a conductor formed of a metal material (for example, copper) and a coating covering the conductor. A tip portion of the conductor is exposed from the coating.

Cable jacket 34 accommodates the plurality of optical fibers 31, the plurality of signal wires 32, and the plurality of ground wires 33 therein. Tip portions of optical fibers 31, signal wires 32, and ground wires 33 are exposed from cable jacket 34.

Holding member 35 is inserted into the tip of cable jacket 34 in a state of surrounding the plurality of optical fibers 31, the plurality of signal wires 32, and the plurality of ground wires 33. Holding member 35 holds the plurality of optical fibers 31, the plurality of signal wires 32, and the plurality of ground wires 33 at the tip of cable jacket 34.

FIG. 3 is a cross-sectional view of connector 2 along line III-III illustrated in FIG. 2. In FIG. 3, housing 25 is also illustrated. As illustrated in FIG. 3, lens module 22 has a plate shape. Lens module 22 includes a main surface 22a, a supporting surface 22b, a back surface 22c, a mirror 22d, a plurality of fiber grooves 22e, a recess 22f, a recess 22g, and a plurality of lenses 22h.

Each of main surface 22a, supporting surface 22b, and back surface 22c intersects with the Z-axis direction (a thickness direction of lens module 22). Each of main surface 22a, supporting surface 22b, and back surface 22c is parallel to an axial direction of optical fiber 31. Each of main surface 22a and supporting surface 22b faces away from circuit board 21. Main surface 22a and supporting surface 22b are arranged side by side along a Y-axis direction. Main surface 22a is located on a side of supporting surface 22b opposite to cable 3 when viewed from the Z-axis direction. Back surface 22c faces away from main surface 22a and supporting surface 22b. Back surface 22c faces circuit board 21.

Mirror 22d is an inclined surface formed at main surface 22a and recessed toward back surface 22c. Mirror 22d is inclined so as to approach back surface 22c as mirror 22d is separated from supporting surface 22b along the Y-axis direction. Mirror 22d is a flat surface parallel to the X-axis direction. Mirror 22d reflects light emitted from optical fibers 31 or light emitted from photoelectric conversion elements 24.

Each of fiber grooves 22e is formed at supporting surface 22b. Each of fiber grooves 22e extends along the Y-axis direction. The plurality of fiber grooves 22e are arranged side by side along the X-axis direction when viewed from the Z-axis direction. Each of fiber grooves 22e has, for example, a V-shape when viewed from the Y-axis direction. That is, each of fiber grooves 22e is, for example, a V-groove. A tip portion of each of optical fibers 31 is supported by supporting surface 22b in a state of being disposed in a corresponding one of fiber grooves 22e. Fiber grooves 22e define the positions of respective optical fibers 31 with respect to lens module 22 and prevent the displacement of respective optical fibers 31 in the X-axis direction.

Recess 22f is formed at supporting surface 22b and is recessed toward back surface 22c. When viewed from the Z-axis direction, recess 22f is located between the plurality of fiber grooves 22e and main surface 22a. When viewed from the Y-axis direction, both ends of recess 22f in the X-axis direction are located outside the plurality of fiber grooves 22e. Recess 22f communicates with each of fiber grooves 22e. Recess 22g is formed at back surface 22c and is recessed toward main surface 22a. When viewed from the Z-axis direction, recess 22g is located inside the outer edge of main surface 22a.

Each of lenses 22h is formed at the bottom surface of recess 22g. Each of lenses 22h protrudes from the bottom surface of recess 22g toward the opposite side of main surface 22a. The plurality of lenses 22h are arranged side by side along the X-axis direction when viewed from the Z-axis direction. The interval between lenses 22h adjacent to each other is the same as the interval between fiber grooves 22e adjacent to each other. The position of each of lenses 22h in the X-axis direction coincides with the position of a corresponding one of fiber grooves 22e in the X-axis direction. The focal point of each of lenses 22h is located, for example, on the surface of a corresponding one of photoelectric conversion elements 24 or inside the corresponding one of photoelectric conversion elements 24. Various parameters of lenses 22h (for example, the surface shape, size, material, and the like of lenses 22h) are optimized based on the relative position between lenses 22h and photoelectric conversion elements 24, and the like.

Each of photoelectric conversion elements 24 is provided at circuit board 21. Each of photoelectric conversion elements 24 is located on the side of first main surface 21a of circuit board 21 opposite to second main surface 21b. Each of photoelectric conversion elements 24 protrudes from first main surface 21a of circuit board 21. The plurality of photoelectric conversion elements 24 are arranged side by side along the X-axis direction when viewed from the Z-axis direction. The interval between photoelectric conversion elements 24 adjacent to each other is the same as the interval between lenses 22h adjacent to each other. The position of each of photoelectric conversion elements 24 in the X-axis direction coincides with the position of a corresponding one of lenses 22h in the X-axis direction. Each of photoelectric conversion elements 24 overlaps with the corresponding one of lenses 22h when viewed from the Z-axis direction. Each of photoelectric conversion elements 24 is, for example, a light receiving element such as a photodiode (PD) or a light emitting element such as a vertical cavity surface emitting laser (VCSEL).

Lenses 22h optically couple photoelectric conversion elements 24 to optical fibers 31, respectively. The light emitted from each of optical fibers 31 is reflected from mirror 22d and then collected by a corresponding one of lenses 22h. The light collected by each of lenses 22h is incident on a corresponding one of photoelectric conversion elements 24. The light emitted from each of photoelectric conversion elements 24 is condensed by a corresponding one of lenses 22h and then reflected from mirror 22d. The light reflected from mirror 22d is incident on a corresponding one of optical fibers 31.

First member 251 of housing 25 includes a main body 253 and a protruding portion 254. Main body 253 has, for example, a rectangular plate shape. When viewed from the Z-axis direction, the outer edge of main body 253 coincides with the outer edge of second member 252. Protruding portion 254 protrudes from main body 253 toward second member 252. Protruding portion 254 overlaps with supporting surface 22b of the lens module when viewed from the Z-axis direction.

Protruding portion 254 faces supporting surface 22b with the plurality of optical fibers 31 interposed therebetween. Protruding portion 254 presses the plurality of optical fibers 31 against supporting surface 22b. In other words, each of optical fibers 31 is pressed by protruding portion 254 in a state of being disposed in a corresponding one of fiber grooves 22e. In the present embodiment, main body 253 and protruding portion 254 are a part of first member 251 which are integrally formed of the same material. That is, main body 253 and protruding portion 254 are integrally formed.

FIG. 4 is a cross-sectional view of connector 2 along IV-IV illustrated in FIG. 2. In FIG. 4, housing 25 is also illustrated. As illustrated in FIG. 4, each of signal wires 32 is located on the side of second main surface 21b of circuit board 21 opposite to first main surface 21a. Tips of signal wires 32 are disposed over second main surface 21b. Each of signal wires 32 is fixed to an electrode pad 212 provided on second main surface 21b of circuit board 21 by, for example, soldering. Thus, signal wires 32 are electrically connected to circuit board 21.

Ground wires 33 are located on the side of first main surface 21a of circuit board 21 opposite to second main surface 21b. Tips of ground wires 33 are disposed over first main surface 21a. Each of ground wires 33 is fixed to an electrode pad 213 provided on first main surface 21a of circuit board 21 by, for example, soldering. Thus, ground wires 33 are electrically connected to circuit board 21.

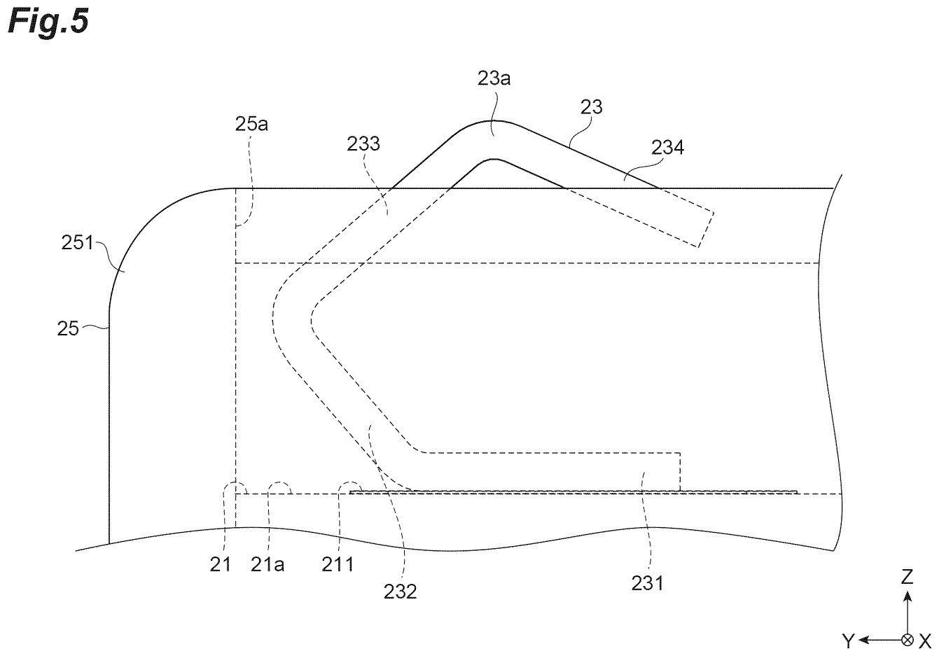

FIG. 5 is a side view of connector 2. As illustrated in FIG. 5, connection terminals 23 have thin plate shapes. Connection terminals 23 electrically connect circuit board 21 to a mating connector. Each of connection terminal 23 includes a first portion 231, a second portion 232, a third portion 233, and a fourth portion 234.

First portion 231, second portion 232, third portion 233, and fourth portion 234 are portions of connection terminals 23 which are integrally formed of the same material. First portion 231 extends along the Y-axis direction. First portion 231 is fixed to electrode pad 211 by, for example, soldering.

Second portion 232 is located on a side of first portion 231 opposite to lens module 22 when viewed from the X-axis direction. Second portion 232 extends along a direction inclined with respect to the Y-axis direction when viewed from the X-axis direction. Second portion 232 extends so as to be separated from circuit board 21 as second portion 232 is separated from first portion 231 along the Y-axis direction when viewed from the X-axis direction. One end of second portion 232 closer to first portion 231 is connected to first portion 231. When viewed from the X-axis direction, an angle between second portion 232 and first portion 231 is, for example, an obtuse angle.

Third portion 233 is located on a side of second portion 232 opposite to circuit board 21 when viewed from the X-axis direction. Third portion 233 extends along the direction inclined with respect to the Y-axis direction when viewed from the X-axis direction. Third portion 233 extends so as to approach lens module 22 as third portion 233 is separated from second portion 232 along the Z-axis direction when viewed from the X-axis direction. One end of third portion 233 closer to second portion 232 is connected to second portion 232. When viewed from the X-axis direction, an angle between third portion 233 and second portion 232 is, for example, a right angle.

Fourth portion 234 is located closer to lens module 22 than third portion 233 when viewed from the X-axis direction. Fourth portion 234 extends along the direction inclined with respect to the Y-axis direction when viewed from the X-axis direction. Fourth portion 234 extends so as to approach circuit board 21 as fourth portion 234 is separated from third portion 233 along the Y-axis direction when viewed from the X-axis direction. One end of fourth portion 234 closer to third portion 233 is connected to third portion 233. When viewed from the X-axis direction, an angle between fourth portion 234 and third portion 233 is, for example, an obtuse angle. Fourth portion 234 is separated from first portion 231. That is, fourth portion 234 is not directly connected to first portion 231.

Connection terminals 23 are configured to be elastically deformable. Connection terminals 23 function as plate springs. Connection terminals 23 can be deformed so that the angles between adjacent portions of the portions 231, 232, 233, and 234 increase or decrease. Each of second portion 232, third portion 233, and fourth portion 234 is movable toward circuit board 21 in a state where first portion 231 is fixed to circuit board 21. A tip 23a of each of connection terminals 23, at which third portion 233 and fourth portion 234 are connected to each other, is movable toward circuit board 21. When a load applied to connection terminals 23 is released, connection terminals 23 return from an elastically deformed state to a natural state (a state in which no internal stress is generated). The materials of connection terminals 23 are, for example, phosphor bronze, beryllium copper, or Corson alloys. Connection terminals 23 have an elastic modulus of, for example, about 100 GPa to 150 GPa.

When connection terminals 23 are in a natural state, tip 23a of each of connection terminals 23 protrudes through opening 25a of housing 25 to the outside of housing 25. Tip 23a is located outside housing 25. When tip 23a is pressed in a state of being electrically connected to the mating connector, a state in which an internal stress for returning connection terminals 23 to a natural state exists is maintained. Thus, the electrical connection between connection terminals 23 and the mating connector is ensured.

As described above, optical connector cable 1 includes connection terminals 23 provided at the surface of circuit board 21. Thus, connection terminals 23 enable circuit board 21 and the mating connector to be electrically connected to each other. Moreover, connection terminals 23 are configured to be elastically deformable. Thus, even if circuit board 21 or the mating connector has dimensional variations, the electrical connection between circuit board 21 and the mating connector is ensured by connection terminal 23. Therefore, according to optical connector cable 1, the electrical connection can be ensured.

Tip 23a of each of connection terminals 23 protrudes through opening 25a of housing 25 to the outside of housing 25. Thus, even if housing 25 has dimensional variations, the electrical connection between circuit board 21 and the mating connector by using connection terminal 23 is ensured.

Housing 25 includes protruding portion 254 that presses optical fibers 31 against supporting surface 22b of lens module 22. Thus, optical fibers 31 are pressed against supporting surface 22b by protruding portion 254, and the displacement of optical fibers 31 is prevented.

Lens module 22, connection terminals 23, photoelectric conversion elements 24, and optical fibers 31 are located on the side of first main surface 21a of circuit board 21 opposite to second main surface 21b. Thus, optical connector cable 1 can be downsized.

Signal wires 32 of cable 3 are located on the side of second main surface 21b of circuit board 21 opposite to first main surface 21a, and ground wires 33 of cable 3 are located on the side of first main surface 21a opposite to second main surface 21b. Thus, both the first main surface and the second main surface of the circuit board can be utilized, and optical connector cable 1 can be downsized. Furthermore, since the degree of freedom in the structure or wiring of optical connector cable 1 is improved, for example, the compatibility with an electric connector cable is improved.

Although one embodiment of the present disclosure has been described above, the present disclosure is not limited to the above-described embodiment.

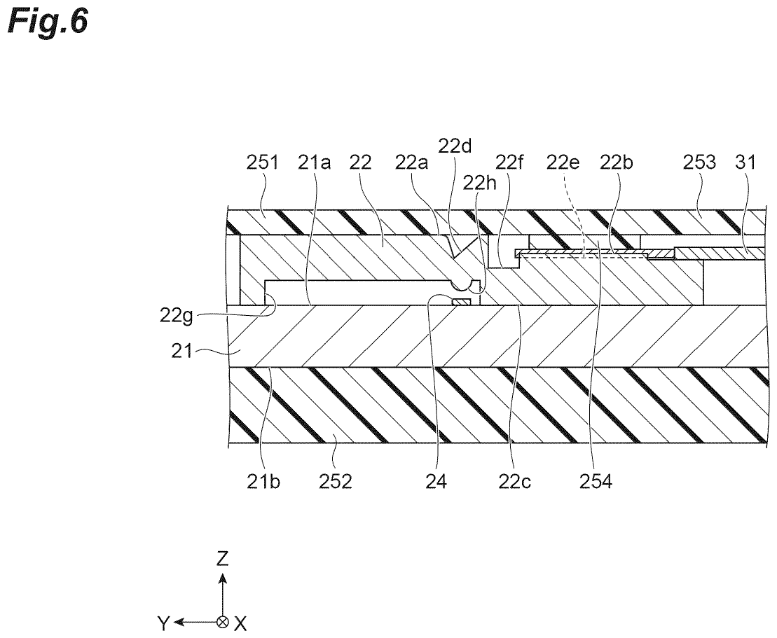

FIG. 6 is a cross-sectional view of an optical connector cable according to a modification. As illustrated in FIG. 6, protruding portion 254 may be formed separately from main body 253. Protruding portion 254 and main body 253 may be separate members.

Cable 3 may not include signal wires 32 and ground wires 33. Cable 3 may include at least optical fiber 31.

Each of connection terminals 23 may be located on a side of second main surface 21b of circuit board 21 opposite to first main surface 21a. Each of connection terminals 23 may be electrically connected to an electrode pad provided on second main surface 21b. In this case, opening 25a is formed in second member 252.

What is claimed is:

1. An optical connector cable comprising:
a circuit board;
a photoelectric conversion element provided at the circuit board;
a cable including an optical fiber configured to propagate light input to the photoelectric conversion element or light output from the photoelectric conversion element;
a lens module including a lens configured to optically couple the photoelectric conversion element to the optical fiber; and
a connection terminal provided at a surface of the circuit board and electrically connected to the circuit board,
wherein the connection terminal is configured to be elastically deformable.

2. The optical connector cable according to claim 1, further comprising:
a housing configured to accommodate the circuit board, the photoelectric conversion element, the lens module, and the connection terminal therein,
wherein the housing has an opening, and
wherein a tip of the connection terminal protrudes through the opening to an outside of the housing.

3. The optical connector cable according to claim 2,
wherein the lens module includes a supporting surface parallel to an axial direction of the optical fiber and configured to support the optical fiber, and
wherein the housing includes a protruding portion facing the supporting surface with the optical fiber interposed between the protruding portion and the supporting surface, the protruding portion being configured to press the optical fiber against the supporting surface.

4. The optical connector cable according to claim 1,
wherein the circuit board includes a first main surface and a second main surface opposite to the first main surface, and
wherein the photoelectric conversion element, the optical fiber, the lens module, and the connection terminal are located on a side of the first main surface opposite to the second main surface.

5. The optical connector cable according to claim 4,
wherein the cable further includes a signal wire electrically connected to the circuit board and configured to transmit an electric signal input to the circuit board or an electric signal output from the circuit board, and a ground wire electrically connected to the circuit board,
wherein the signal wire is located on a side of the second main surface opposite to the first main surface, and
wherein the ground wire is located on the side of the first main surface opposite to the second main surface.

6. The optical connector cable according to claim 1,
wherein the connection terminal is disposed away from a tip of the optical fiber.

7. The optical connector cable according to claim 1,
wherein the connection terminal includes a first portion extending along a direction parallel to the surface of the circuit board, and the first portion is fixed to an electrode of the circuit board.

8. The optical connector cable according to claim 2,
wherein the opening is formed at a surface of the housing near a tip of the optical connector cable.

9. The optical connector cable according to claim 2,
wherein the connection terminal includes a plurality of connection terminals, and each tip of the plurality of connection terminals protrudes through the opening to the outside the housing.

10. The optical connector cable according to claim 2,
wherein the housing is formed from an insulating material, and the connection terminal is provided at the surface of the circuit board so as not to contact the housing.
